(19) United States
(12) Patent Application Publication
(10) Pub. No.: US 2016/0300041 A1
(43) Pub. Date: Oct. 13, 2016

(54) METHOD FOR PATIENT REGISTRATION AT HEALTHCARE FACILITY

(71) Applicant: AGFA HEALTHCARE NV, B-Mortsel (BE)

(72) Inventors: Roel ADRIAENSENS, Mortsel (BE); Wannes KIECKENS, Mortsel (BE); Zhouzhou XU, Mortsel (BE); Yi XUAN ZHANG, Mortsel (BE)

(73) Assignee: Agfa HealthCare NV, Mortsel (BE)

(21) Appl. No.: 15/036,865

(22) PCT Filed: Nov. 18, 2014
(86) PCT No.: PCT/EP2014/074875

§ 371 Date: May 16, 2016

(30) Foreign Application Priority Data
Nov. 27, 2013 (EP) 13194602.2

(51) Int. Cl. G06F 19/00

(52) U.S. Cl. CPC G06F 19/363

(57) ABSTRACT

A method for patient registration at a healthcare facility includes the steps of creating an order for a medical examination for the patient in a computer system of the healthcare facility, retrieving an electronic questionnaire from a data repository accessible by the computer system, completing the electronic questionnaire with data provided by the patient, and synchronizing data from the completed questionnaire with the order in the computer system.

### CROSS-REFERENCE TO RELATED APPLICATIONS

This application is a 371 National Stage Application of PCT/EP2014/074875, filed Nov. 18, 2014. This application claims the benefit of European Application No. 13194602.2, filed Nov. 27, 2013, which is incorporated by reference herein in its entirety.

### BACKGROUND OF THE INVENTION

1. Field of the Invention

The present invention relates to a method for patient registration in a medical facility.

2. Description of the Related Art

When registering at a medical facility where an examination is going to take place for a patient, the patient has to provide a lot of administrative data, e.g. identification data such as his name, address, date of birth etc. as well as some data relating to his medical history.

Commonly a patient presents himself at the registration desk of the hospital and places an order for a certain type of examination. At the registration desk he then receives a questionnaire to be filled out. Nowadays such a questionnaire is commonly an image type or pdf type document which comprises a number of fields to filled out regarding patient identification data, demographic data, medical history information, information on medication the patient is currently taking, medical history of relatives etc. The questionnaire often is a general, common form used for all types of orders and examinations and patients.

The patient then needs some time to fill out the questionnaire, signs it and returns the completed questionnaire to the hospital secretary.

The medical secretary next checks whether the questionnaire is complete and signed, scans the signed questionnaire and uploads the document into the available information system, e.g. the radiology information system (RIS).

Additionally the medical secretary has to manually update some information, such as recent clinical information into the information system available at the medical facility.

For example recent data on patient height and/or weight, allergy information, pregnancy information etc. need to be updated in the information system.

As a consequence of the new information provided in the filled out questionnaire the order or the examination may have to be changed or adapted. For example when the patient informs the hospital by filling out the questionnaire that she is pregnant, it is possible that a certain order for that patient needs to be adapted.

Finally the order creation workflow is finalized. This prior art workflow is illustrated in FIG. 1.

This prior art workflow is cumbersome for the patient since he may have to provide similar data repeatedly, each time he visits the medical facility. This takes time and is annoying.

Furthermore, the printed form is in most cases not specifically adapted to the order that is envisaged and may thus ask more input from the patient than is required.

The workflow is also cumbersome for the administrative personnel since they have to scan the filled out document and enter it into the information system. This procedure is thus time consuming and is error-prone.

Additionally they have to update the information in the information system manually and they have to update the order in some circumstances. The information filled in in the printed form used nowadays does not have any interaction with or link to the type of patient (e.g. a female patient) or the type of order or the workflow.

There is thus a need for an enhanced workflow method.

US patent application 2011/0246216 discloses techniques for enabling a patient to pre-register for patient intake in a medical facility on-line. Customized forms can be created by the hospital staff, these forms can be pre-populated with patient's health data from a network-accessible patient-controlled repository of health data. Patients can fill in the form on an end user computing device offering on-line access to the form. An update can be performed of the data filled in by the patient in the patient-controlled repository of health data.

### SUMMARY OF THE INVENTION

The above-mentioned aspects are achieved by a method as described below.

Specific features for preferred embodiments of the invention are also set out below.

Further advantages and preferred embodiments of the present invention will become apparent from the following description and drawings.

### BRIEF DESCRIPTION OF THE DRAWINGS

FIG. 1 illustrates the prior art workflow.

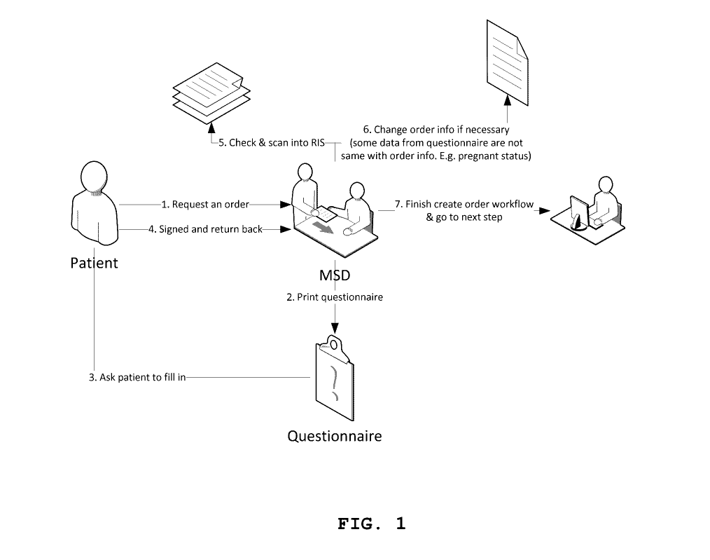

FIG. 2 schematically illustrates the enhanced workflow according to a preferred embodiment of the present invention.

FIG. 3 is a flowchart illustrating different steps of a method of the present invention.

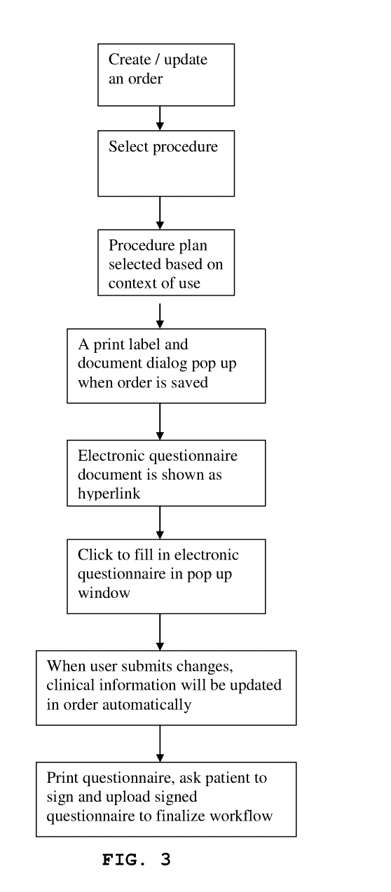

FIG. 4 illustrates an example of computing infrastructure on which the workflow can be performed.

FIG. 5 is an example of a questionnaire form.

### DETAILED DESCRIPTION OF THE PREFERRED EMBODIMENTS

Hereinafter a workflow method is described for patient registration at a medical facility.

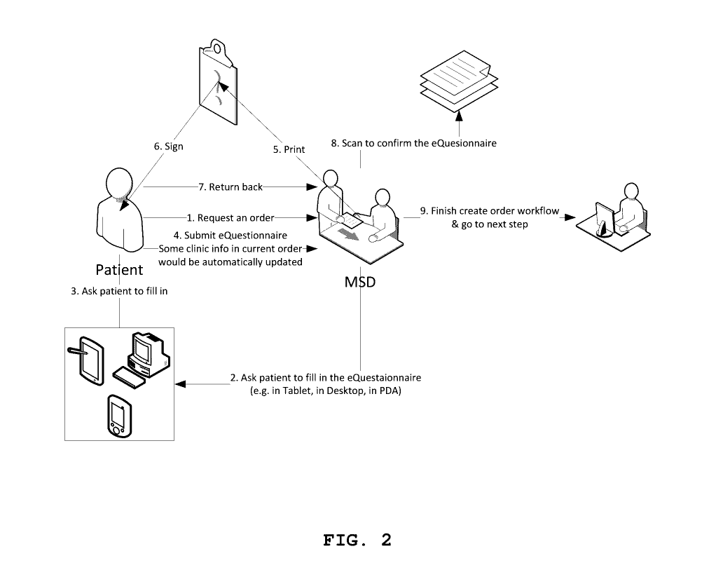

The different steps of the workflow are shown in FIG. 2.

In a first step (step 1) the patient requests an order at the reception desk of the medical facility, he hereby requests that a certain medical examination would be performed. The fact that a medical examination is going to be performed for this patient implies that a workflow pre-defined for this examination is going to be started and followed. Such a workflow comprises a number of successive activities as well as related responsibilities (person that is going to perform a workflow step). Such workflows are predefined and stored in an information system, such as the radiology information system of a hospital (RIS).

In the context of the present invention a medical facility may be a hospital or a sub-division of a hospital or a physician's office or any other facility where a patient can have a medical examination done and where he is expected to provide identification data, information on his health record or history and the like.

Next (step 2), the medical secretary at the reception desk retrieves an electronic questionnaire which is displayed on an electronic display of a mobile or desktop data processing device accessible by the patient such as a tablet, desktop computer, personal digital assistant or the like.

This electronic questionnaire is preferably a customized questionnaire dedicated to the order that has been requested at the reception desk.

The customizing of the electronic questionnaire document can be performed in advance and generally consists of building a questionnaire with a number of fields which are required for a certain order or workflow or for a certain healthcare provider. For example, some field are dedicated to an order relating to a female patient, e.g. pregnancy information, other fields may come from a medical dictionary. Other fields are customized to the type of order rather than to the patient.

By customizing the questionnaire, a hierarchy of fields can be created such that for example in case of a female patient ordering a CT scan, the field concerning pregnancy information is a mandatory field for this type of questionnaire.

In a specific preferred embodiment the questionnaire is implemented as a standard html file. The page can be defined by the user. The user can start from a template and customize data such as a logo, the layout and certain questions to be responded as are required for the specific examination that is ordered. The user can further configure certain structure data as ‘required’. Examples of such structure data are patientInfo (including patient ID, patient name, gender, date of birth), patientPregnancyInfo unknown, yes, no), patientAllergyInfo yes, no, category, allergy, severity, identification date, reaction), procedureInfo (ordered procedure, requesting physician, scheduled date and time), patientMeasureInfo (including patient height and patient weight) etc.

Also some unstructured data may be configured as ‘required’.

The questionnaire may be pre-populated with data that are retrieved from a data repository such as a hospital information system (HIS) or a radiology information system (RIS) in which data on the patient and/or his health record have been stored and that is accessible via network for the person who composes the questionnaire, e.g. the hospital administrator.

Still further conditions may be generated for checks and warnings, such as a warning popping up when the patient is pregnant and the order type is an examination on a CT modality.

The customized questionnaire can be packed as a ZIP file and uploaded via UCT (Unified configuration tools) document management tools, which are centralized management tools that are used by a system administrator to configure the RIS system.

It is also possible that some workflow dependent functions automatically sync with the order information.

It is possible to link the customized electronic questionnaire in a procedure plan step as a prescribed document.

When a procedure plan has been applied in a study, the prescribed documents would link to related tasks automatically (the tasks are created base on procedure plan step).

The user can also add some additional questionnaire documents to the study.

The patient is then asked to fill out this questionnaire (step 3) by completing the requested information into the displayed dedicated fields of the displayed questionnaire.

Once the questionnaire is filled out, it is submitted and some of the information is automatically updated in the requested order (e.g., A female user change the pregnancy status from no to yes in questionnaire and submit the information, it would update the pregnancy info to current order) (step 4).

The filled out questionnaire is finally signed off and uploaded into the information system as a piece of evidence (step 5).

In one preferred embodiment (step 5) the filled out electronic questionnaire is printed for this purpose and handed over to the patent for signing.

The signed questionnaire is then scanned and confirmed. It constitutes a document with legal effect. It can be uploaded to the system to be archived. (step 8)

Since the information in the questionnaire is available as digital information, it can be used to update the order information thereby avoiding manual updating by the administrator.

Furthermore, it is possible to synchronize the data filled in by the user to the order information.

The order creation can then be finalized and the medical secretary can proceed to a following step. (step 9)

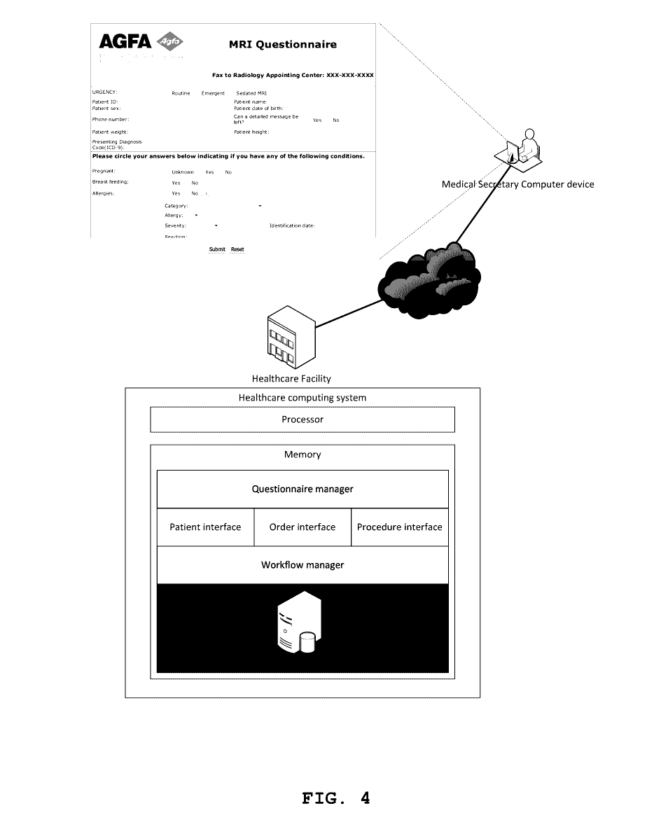

FIG. 4 illustrates an example of a computer infrastructure suitable for performing a method of the present invention.

The infrastructure comprises at least one end-user computer device having a display screen with a user-interface (UI) allowing a user, e.g. a patient who is performing registration at hospital intake desk, to fill in an electronic questionnaire.

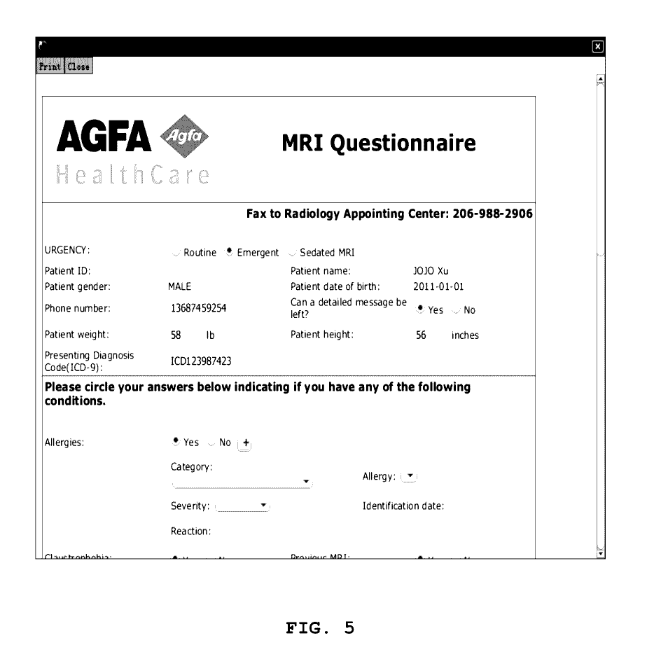

An exemplary questionnaire form is shown in FIG. 5.

The shown questionnaire is a sample MRI questionnaire form comprising the following fields: URGENCY STATUS, patient info, clinic info (pregnancy, allergy . . . ), questions and a “Submit” option for sending the information to the healthcare facility.

The end-user computing device is typically a computer that is coupled via a network to the healthcare facility. The computing device has processor, memories, storage systems, and input/output subsystems, such as a keyboard, mouse, monitor, speakers, etc. The end-user computing device typically is running one or more application programs, such as a browser to fill out the questionnaire and print it. The computing device may be a smart phone, a tablet, or any other suitable computing device.

The communications network, meanwhile, represents any one of or a combination of multiple different types of networks, interconnected with each other and functioning as a single large network (e.g., the Internet, the Web, or an intranet). Physically, the network may include wire based networks (e.g., Ethernet, cable, dial-up telephone cabling, etc.) and/or wireless networks (e.g., local wireless network hub, wireless hotspot, mobile, cellular, satellite, etc.).

As depicted, the hospital includes a healthcare computing system. While the healthcare computing system services the hospital, the system may physically exist partially or fully offsite from the hospital itself. Also while shown here as one computing system, the healthcare computing system is likely to consist of multiple computing devices, systems, and subsystems that are physically located across multiple locations in the hospital and often may other hospitals and sites.

As illustrated, the healthcare computing system includes one or more processors and one or more memories. The healthcare computing system further comprises multiple components, such as a Workflow manager, a Patient interface, Order interface and a Procedure interface and a Questionnaire manager.

The healthcare computing system may also have storage systems, other memories, and input/output subsystems such as a keyboard, mouse, monitor, speakers, etc. Indeed, the healthcare computing system may include one or more data storage subsystems and distributed computing and/or network access mechanisms through which other hospital terminals or computing devices may gain access.

Using the questionnaire manager, a hospital staffer may upload and preview a questionnaire, link the questionnaire to a procedure plan step to add the information automatically added to a planned procedure. The questionnaire is then automatically deployed to the computing system.

Using the questionnaire manager, each hospital may use standard pre-generated questionnaire or may upload new questionnaire specific to a particular healthcare facility (e.g., Hospital 1 or Hospital 2 in the same hospital system), particular departments (e.g., oncology, obstetrics, neurology), and particular physicians (e.g. Dr. Jones), or other healthcare provider.

Via the patient interface a particular intake form which is selected is presented to the user who can populate the questionnaire with data.

The order interface selects the particular intake form to be presented to the user and populates the questionnaire with data such_as request procedure information such as scheduled procedure name, scheduled data time and reading physician.

The procedure interface selects the particular intake form presented to the user and populates the questionnaire with data.

The Workflow manager is triggered when a user changes the pre-filled clinical info when filling in the questionnaire (e.g., change pregnant status a warning dialog would be triggered).

The electronic questionnaire used in a preferred embodiment of the present invention can be separated in 3 parts:

(1) Patient and procedure information part,

(2) Structured data and

(3) Unstructured data.

The patient and procedure information part typically comprises Patient demographic information such as Patient's name, Patient's date of birth, Patient's gender, Patient's identification number, Procedure specific information, Scheduled date and time, Requested procedure name, Requesting physician.

The structured data typically comprises information on allergies, pregnancy, patient safety hazard, medical conditions, patient mobility, patient weight & height.

The unstructured data may e.g. comprise some questions which do not sync with the order information.

The patient and procedure information could be automatically filled in into the questionnaire. This can help the medical secretary to check whether the correct patient is involved. Automatic filling of the data avoids that the patient has to fill out the same data again.

The structured data will sync with order/clinic in RIS system automatically. This means that in case a user changes the data of a structured data filed it will affect the order and the workflow.

For example, a medical secretary may create an order for a patient and indicate that the patient is not pregnant. (pregnancy: NO)

Hereafter the patient fills in the questionnaire and changes the pregnancy status to Yes and fills the data concerning the last menstrual period in as having occurred 2 months ago.

The fact that these structured data are changed would automatically sync to the clinical information.

As a result hereof, an automatic pregnancy warning will pop up when technologist starts the task for this patient asking the technologist to confirm that the pregnant check warning is enabled.

For each questionnaire some properties ID (identification) for structured data are pre-defined, for example allergy, pregnancy and patient weight/height.

If the customized questionnaire includes one of these identifications and the value is validated, these properties are used to update the information for current order.

At workflow level some checks can be defined e.g. on this allergy/pregnancy information and some actions can be initiated in dependence of the result of these checks.

For example when order is saved giving the information that the patient is female and the modality type is CT then a dialog window would pop up asking the medical secretary to check with the patient whether the pregnancy status is correct

The examination in this case would have high risk for the pregnant patient so a change of the order to another type of modality like MRI would be recommended.

Having described in detail preferred embodiments of the current invention, it will now be apparent to those skilled in the art that numerous modifications can be made therein without departing from the scope of the invention as defined in the appending claims.

1-5. (canceled)

6: A method for patient registration at a healthcare facility, the method comprising the steps of:
creating in a computer system of the healthcare facility an order for a medical examination of a patient;
retrieving an electronic questionnaire from a data repository accessible by the computer system of the healthcare facility;
completing the electronic questionnaire with data provided by the patient; and
synchronizing data from the completed electronic questionnaire with the order in the computer system of the healthcare facility.

7: The method according to claim 6, further comprising the step of displaying the electronic questionnaire on a display device coupled to the computer system of the healthcare facility.

8: The method according to claim 6, wherein the electronic questionnaire is customized for the order.

9: The method according to claim 6, further comprising the step of pre-populating the electronic questionnaire with information concerning the patient and/or the order, or concerning a predefined workflow associated with the order, wherein the information is retrieved from the data repository accessible by the computer system of the healthcare facility.

10: The method according to claim 6, further comprising the steps of:
printing the completed electronic questionnaire;
prompting the patient to sign the printed completed electronic questionnaire; and
scanning and up-loading the signed electronic questionnaire into the data repository to update the order or a workflow associated with the order.
